(19) United States
(12) Patent Application Publication
(10) Pub. No.: US 2008/0193896 A1
(43) Pub. Date: Aug. 14, 2008

(54) SYSTEM FOR FACILITATING DENTAL DIAGNOSIS AND TREATMENT PLANNING ON A CAST MODEL AND METHOD USED THEREOF

(76) Inventors: Been-Der Yang, Taipei (TW); Jaw-Lin Wang, Taipei (TW); Yao-Hung Wang, Taipei (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/020,035

(22) Filed: Jan. 25, 2008

(30) Foreign Application Priority Data
Feb. 14, 2007 (TW) 096105573

(51) Int. Cl. A61C 13/34

(52) U.S. Cl. 433/68; 433/215

(57) ABSTRACT

The present invention relates to a system integrating three-dimensional anatomical information with a cast model. The system combines the advantages of a digitalized three-dimensional image and the virtues of a cast model. Users may utilize a fully integrated environment provided by the present invention to make treatment planning more promptly and accurately.

### BACKGROUND OF THE INVENTION

1. Field of the Invention

This invention is directed to a system for facilitating dental diagnosis and treatment planning by the use of a cast model. More particularly, this invention relates to a system integrating three-dimensional anatomical information with a cast model. The system of the present invention is useful in that it combines the advantages of a digitalized three-dimensional image and the virtues of a cast model. Users may utilize a fully integrated environment provided by the present invention to make treatment planning more promptly and accurately.

This invention also relates to a method for providing an environment in which a user may establish the correlation between three-dimensional anatomical information and a cast model so as to evaluate and plan a subsequent surgical operation.

2. Description of the Related Art

Pre-operative evaluation plays an important role in a dental treatment. To gain a better understanding of a patient's condition in dental diagnosis and treatment planning, dentists have to consult a variety of information sources. Among them, both plaster cast models and X-ray radiographs are important yet in a different way. Cast models provide dentists the occlusal condition and aesthetic function of a patient's teeth, which is external information, whereas X-ray radiographs provide dentists the internal anatomical information of the patient's teeth and jaw bone, which is critical in some dental treatments, such as dental implant surgery, root canalling, impacted tooth extraction, and temporomandibular joint (TMJ) evaluation.

Although the information provided by cast models and X-ray radiographs may be complementarily important to a dentist, they are treated separately most of the time, and mental conversion of the dentist is always required for the association between the two valuable information sources. For example, a dental implant direction has to be determined in an X-ray radiograph first based on a patient's jaw bone condition. To transfer the implant direction back to the cast model, the dentist has to apply anatomical landmarks thereafter so that the occlusal condition and aesthetic function can be evaluated on the cast model before the treatment. Such diagnosis procedures, although still used by most dentists, are ineffective and error-prone.

To address the inconvenience resulted from utilizing the two information sources individually, several solutions have been proposed. Basically, these solutions can be classified into two categories. One type of inventions integrates information carried by a virtual, three-dimensional digital image into a cast model, enabling users to evaluate and plan a treatment with a tactile, dentist-friendly cast model. For example, U.S. Pat. No. 5,133,660 discloses a casting device capable of transferring an X-ray radiograph image into a cast model so that the evaluation of a dental implant may be done on the cast model. By cutting the casting transversely close to the implant site, the X-ray image showing the internal structure of a patient's jaw bone may be aligned to the cut plant of the cast model through buried X-ray opaque reference grids. However, since the cutting plane can only be cut once, and there is no chance to evaluate alternative position and orientation, this approach fails to offer necessary flexibility.

In contrast, the other type of inventions integrates the information carried by a cast model into a three-dimensional digital model. The three-dimensional digital model used by this approach is sometimes called an electronic study model because all data carried by both information sources are unified into one digital model. In U.S. Pat. No. 5,562,448, a method is proposed that transfers the information carried by a cast model into a three-dimensional digital model and subsequently transmits the digital model to a computer system incorporating various types of imaging information sources. Similarly, U.S. Pat. No. 7,133,042 discloses a system for integrating anatomical information from a plurality of sources, including the plaster cast model and the X-ray radiograph, into a digitalized environment. This approach is flawed in that the stereo visualization and tactile strength provided by the cast model will no longer exist once the cast model is converted into its digital counterpart. Even though various technologies are now available to resolve the difficulties, such as the stereo optical technique for restoring the depth information and the force feedback device for enhancing the tactile sensing capability of the system, they inevitably needs to be operated with the presence of extra facilities; thus, these techniques are doomed to incur unnecessary costs.

### SUMMARY OF THE INVENTION

To combine the advantages of X-ray radiographs and cast models, the present invention provides a system for facilitating dental diagnosis and treatment planning directly on the cast model, which associates with, in real time, the anatomical information presented by imaging graphics. On the one hand, the use of the cast model preserves the vivid three-dimensional visualization and tactile feedback, allowing a dentist diagnosing and planning the dental treatment in a more intuitive way, which are not provided by its digital replica. On the other hand, the real-time association of the anatomical imaging information with the interested spot on the cast model increases the throughput of the diagnosis and evaluation process because there is no need for the dentist to perform mental conversion between different dental information sources which are taken separately.

The system of the present invention mainly comprises a computer, a registration marker object, and a localization means. Said computer is capable of reading three-dimensional anatomical information comprising fiducial marker information and rendering an anatomical image corresponding to the three-dimensional anatomical information; the three-dimensional anatomical information may be selected from intral-oral radiographic data, panoramic radiographic data, tomographic radiographic data, and, more preferably, computed tomographic radiographic data.

The registration marker object is an object comprising at least one fiducial marker which is imageable and measurable under different circumstances; thus, its position in the image space can be identified by the use of feature identification algorithm, and it may be measured by the localization means in the physical space in the meantime. Preferably, the registration marker object comprises a main part on which the fiducial marker is disposed; the main part may be a casting with a negative impression of teeth taken from a cast model. In use, the registration marker object may be mounted on the cast model, working as a reference for providing necessary spatial information for the navigation.

The localization means is applied in this invention as a tracer to identify and record the coordinate of a point on or around the cast model. Typically, it has a stylus probe for probing the cast model, and the spatial status, including the position and orientation, of the tip of the stylus probe in a predefined space may be transmitted to the computer so as to specify the display of the anatomical image. The localization means may be but not limited to a stereo optical sensor, a magnetic field sensor, an ultrasonic time-of-flight device, or, more preferably, a articulated arm.

In addition, the present invention also provides a method by which a dentist may view a three-dimensional image of a patient's jaw bone in a real-time manner by pointing the tip of a localization means at a point of interest. The method comprises the following steps: mounting a registration marker object comprising at least one fiducial marker onto a cast model secured at a predetermined place; transmitting position information corresponding to the fiducial marker to a computer, wherein the computer is loaded with three-dimensional anatomical information comprising fiducial marker information; aligning the three-dimensional anatomical information and the position information; and receiving spatial information of a point on the cast model and displaying an anatomical image corresponding to the spatial information.

Other objects, advantages, and novel features of the invention will become more apparent from the following detailed description when taken in conjunction with the accompanying drawings.

### BRIEF DESCRIPTION OF THE DRAWINGS

FIG. 1 is an illustrative diagram of the system of the present invention.

FIG. 2 is a flowchart showing the steps of the method of the present invention.

FIG. 3 illustrates the status during the registration step of each component of the system of this invention.

FIG. 4 illustrates the status during the navigation step of each component of the system of this invention.

### DETAILED DESCRIPTION OF THE PREFERRED EMBODIMENT

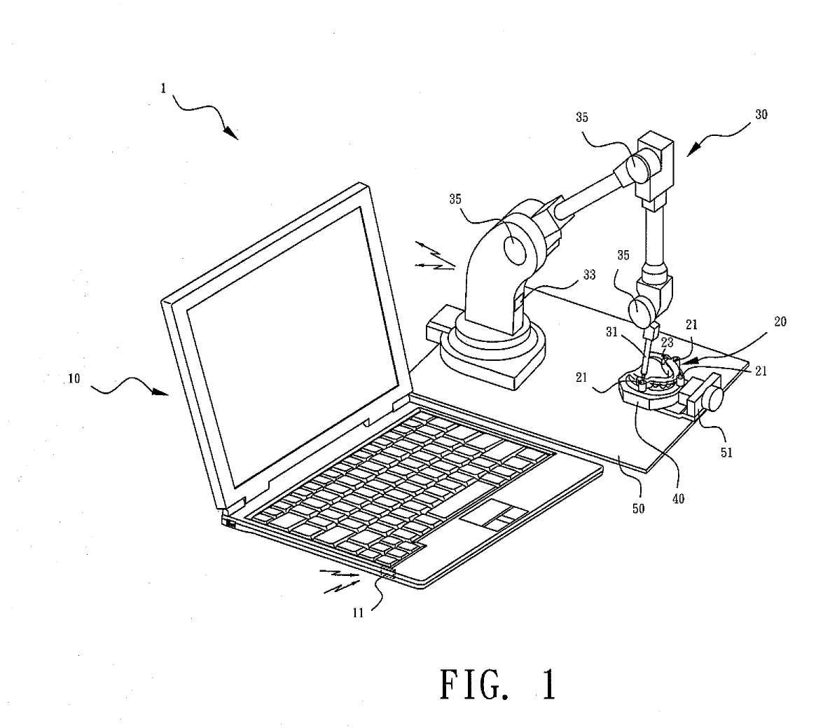

First, refer to FIG. 1 for an illustrative diagram of the system 1 of the present invention. As shown in FIG. 1, the system 1 mainly comprises three parts: a computer 10, a registration marker object 20, and a localization means 30. The computer 10 is applied herein to render an anatomical image; it is capable of reading three-dimensional anatomical information which further comprises fiducial marker information and rendering the anatomical image corresponding to the three-dimensional anatomical information. Typically, the anatomical information is X-ray radiographic data taken from a patient wearing the registration marker object 20; more specifically, it is X-ray radiographic data of a patient's jaw bone. The three-dimensional anatomical information may be selected from intral-oral radiographic data, panoramic radiographic data, tomographic radiographic data, and, more preferably, computed tomographic radiographic data. All the data aforementioned may be obtained from various three-dimensional image modalities such as computed tomography (CT) scanner, magnetic resonance imaging (MRI) machine, or ultrasonic device. The computer 10 is loaded with the three-dimensional anatomical information of a patient, and an imaging software installed in the computer 10 may display the anatomical image corresponding to the three-dimensional anatomical information. Since the imaging software for rendering anatomical images from three-dimensional anatomical information is a known technique, further elaboration is omitted herein.

Once the anatomical image is displayed, a dentist may manipulate it with an input device, such as a mouse or a keyboard. On the three-dimensional anatomical image, the dentist may generate an oblique cross-sectional image along a cutting plane by giving a command related to the cutting plane so as to reveal the internal structure of the patient's jaw bone. For example, when a cutting plane across the dental arch of the jaw is specified, the system will display a tomographic image, which is familiar to most dentists. Such a software generated tomographic image is more flexible than its hardware counterpart generated by a tomography system, such as Denar Quint Sectograph Image System (Denar Corp, USA) and Planmeca ProMax (Planmeca Oy, Finland). The flexibility is important to the present invention for dental diagnostic evaluation in two aspects. First, the dentist can easily change the orientation and position of the cutting plane, without the presence of the patient, to navigate through the internal structure of the patient's jaw anatomy around the area of interest; otherwise, if the hardware imaging system is used, another radiograph must be taken. Second, it provides an electronic link for the localization means 30 so that the tip position of the probe can be transferred to the computer 10 to show the internal structure at the target position of the probing spot.

The registration marker object 20 is an object comprising at least one fiducial marker 21 which is imageable and measurable so that its position in the image space can be identified by the use of feature identification algorithm, and it may be measured by the localization means in the physical space in the meantime. In this embodiment, the registration marker object 20 comprises three fiducial markers 21. As shown in FIG. 1, the fiducial marker 21 is a bead; however, it should be noted that any fiducial marker 21 may also be used in other forms. For example, a fiducial marker may be a tube, a cone, or other objects with different geometric shapes. Since the principal function of a fiducial marker is to define a plane, a tube and a bead, as well as a cone, may serve the same function as the three beads disclosed in this invention.

The image data resides in a coordinate system of the computer 10 is referred to as image space; while the coordinate system of the localization means 30 is referred to as physical space. When the apparatuses of the present invention power on, the image space of the computer 10 has no association with the physical space of the localization means 30. In order to relate the image anatomical data to its corresponding physical location on a cast mode 40, one-to-one mapping between the points of the image space and the physical space must be established. This is known as registration procedure, which is established using the registration marker object 20 in accordance with the present invention. Typically, the registration marker object 20 may comprise a main part 23 on which the fiducial markers 21 attached; the main part 23 has one side fabricated as a negative impression of teeth taken from the cast model 40 tailored in accordance with the patient's condition, so it may cap the cast model 40 tightly.

In addition, the fiducial markers 21 of the invention possess correspondingly desirable properties in accordance with the three-dimensional image modality. For example, when a computed tomography machine is used as the three-dimensional image modality for collecting patient's anatomical data, the fiducial markers 21 shall be imageable without producing too much interference or artifact.

The localization means 30, which is used herein as a tracer, is a device capable of providing spatial information of a point of interest, wherein the spatial information shall include the position and orientation of the point. As shown, the localization means 30 may be an articulated arm having several hinges 35, providing multiple degrees of freedom. One end of the articulated arm is a stylus probe 31 whose tip is used to probe and measure the point of interest. The spatial information of the point may then be transmitted to computer 10 to specify the display of an image through a wireless module 33. The signal transmitted from the wireless module 33 may be received by a receiver 11 installed in the computer 10.

What should be noted is that other devices capable of recording the spatial information of a point may also be adopted by the present invention; for example, the localization means 30 may also be a stereo optical sensor, a magnetic field sensor, or an ultrasonic time-of-flight device. Also, the transmission between the localization means 30 and the computer 10 may be carried out by a wire connecting to the two.

In order to fix the relative positions of the localization means 30 and the registration marker object 20 capping the cast model 40, they may be secured on a plate 50 having a fastener 51. The registration marker object 20 and the cast model 40 are secured tightly by the fastener 51 so that they will not change their positions during the operation.

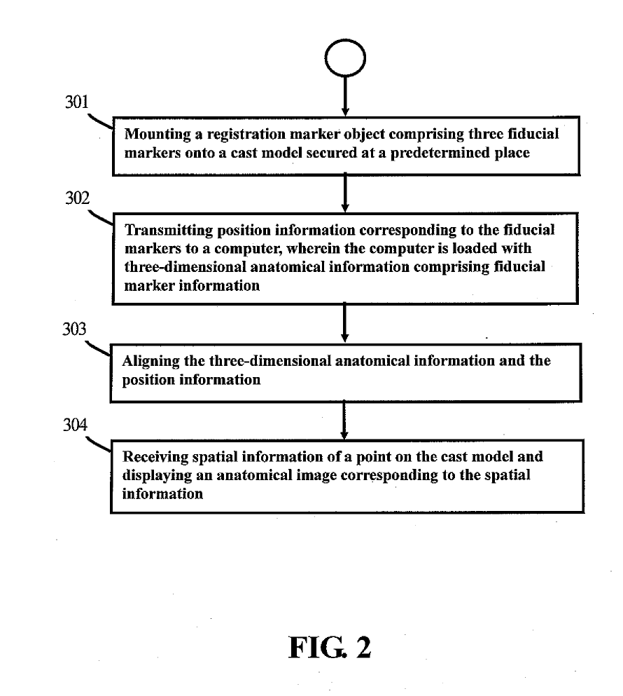

Refer now to FIG. 2 for a flowchart showing the steps of method of the present invention; meanwhile, take FIG. 1 as an auxiliary reference.
Step 301: Mounting a registration marker object comprising at least one fiducial marker onto a cast model secured at a predetermined place.

To take advantage of the vivid three dimensional visualization and tactile feedback of the cast model 40 as well as the real-time representation of a patient's anatomical image, a user has to have the three-dimensional anatomical information and the cast model at hand. The three-dimensional anatomical information may be obtained from different modalities, including a computed tomography scanner, a magnetic resonance imaging machine, and an ultrasonic device, wherein the anatomical information is collected from the patient wearing the registration marker object 20. The identical registration marker object 20, which has at least one fiducial marker, is then mounted on the cast model 40 made in accordance with the patient's teeth, wherein the cast model 40 is secured by the fastener 51.
Step 302: Transmitting position information corresponding to the fiducial marker to a computer, wherein the computer is loaded with three-dimensional anatomical information comprising fiducial marker information.

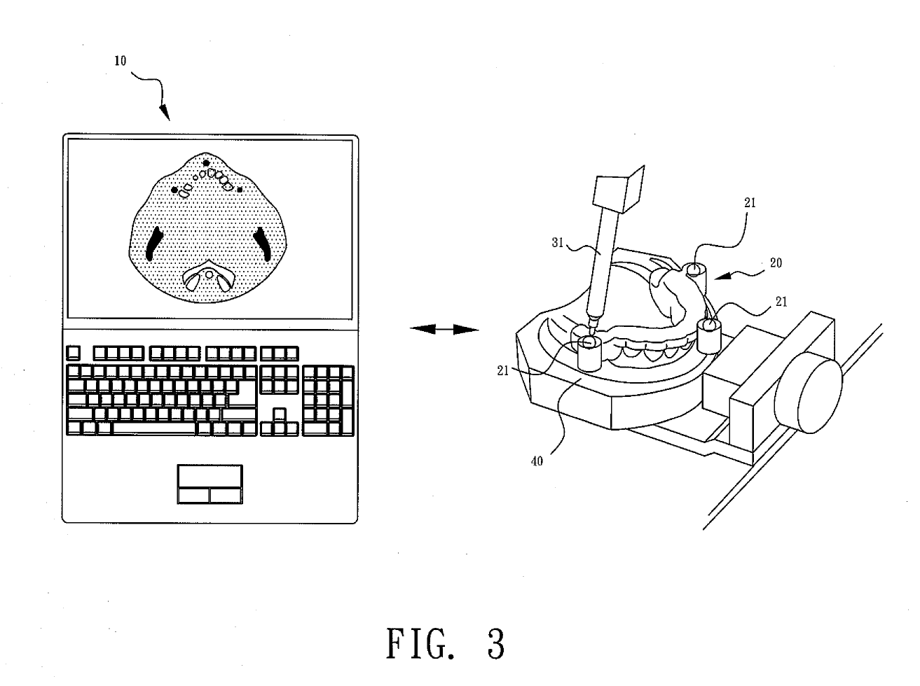

Refer now to FIG. 3, an illustrative diagram showing the status of the system during the registration. In order to carry out the registration step, which fits the points of the image space and the physical space, the user has to transmit the position information of the fiducial markers 21, namely, the information of the physical space, to the computer 10 by directing the tip of the stylus probe 31 to the fiducial markers 21 respectively to get necessary spatial information and sending them to the computer 10 in either wireless or wired means. Again, the number of the fiducial marker 21 is not limited to three but depends on their geometric shapes. For example, if a cone is used as the fiducial marker, no extra fiducial markers will be needed. As mentioned above; the computer 10 has been loaded with the patient's three-dimensional anatomical information containing the fiducial marker information of the image space. In FIG. 3, one can notice that on the screen of the computer 10 is the axial cross-sectional image of a patient's jawbone anatomy, which is converted from the patient's three-dimensional anatomical information by an imaging software, and the three dots in the image represent the image of the fiducial markers 21. After finishing the measurement of the fiducial markers 21, the user then transfers the spatial information of the fiducial markers 21 to the computer 10.
Step 303: Aligning the three-dimensional anatomical information and the position information.

After gathering the position information of the fiducial markers 21, the user will have to specify the corresponding three dots shown on the screen of the computer 10 with the input device. It should be noted that the sequence of the indication of the dots plays no weight in this invention (i.e., one may specify the dots in the computer 10 first before indicating the fiducial markers 21 in the physical space). After collecting all the information about the physical space and the image space, the computer 10 may then be applied to establish a rigid body transformation matrix between the image space and the physical space by aligning the three-dimensional anatomical information and the position information. The transformation matrix resulting from this registration process will be stored in the computer 10 and then used to transform the position and orientation of the stylus probe 31 into the image space, so that any subsequent cross sectional image associated with the target probing location of the cast model 40 can be shown correspondingly.
Step 304: Receiving spatial information of a point on the cast model and displaying an anatomical image corresponding to the spatial information

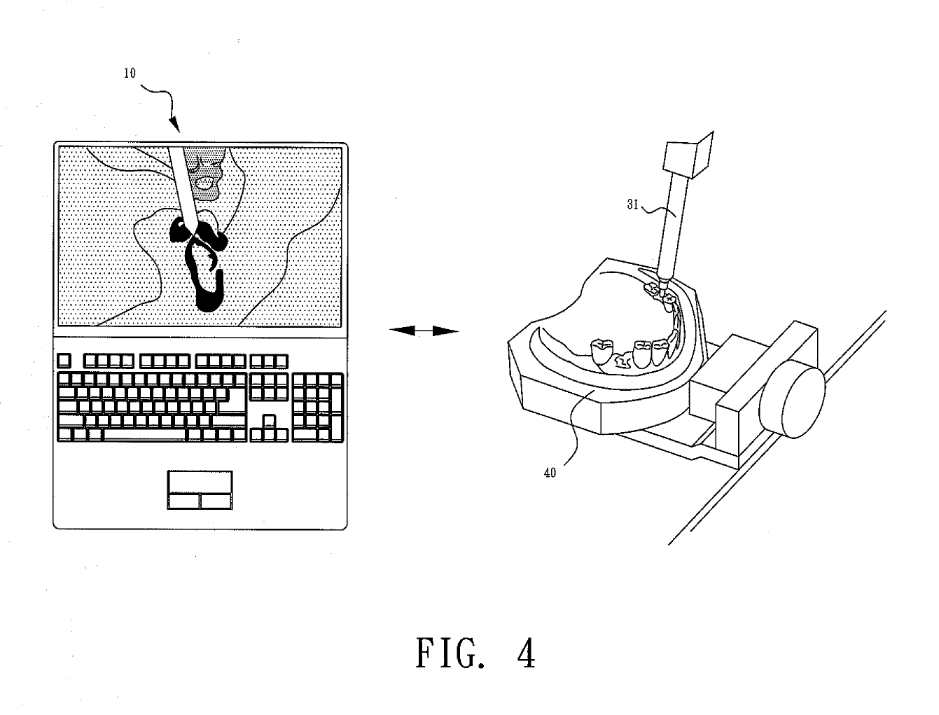

Refer now to FIG. 4. When the registration has been set up, the user may then navigate the cast model 40 by directing the stylus probe 31 to any spot of interest. As shown, the user points the stylus probe 31 into an interested spot on the cast model 40, and the three-dimensional spatial information of the tip of the stylus probe 31 is directly transferred to the computer 10, forming a cutting plane passing through the stylus probe 31 and its tip. The cutting plane is then used by the computer 10 to cut through the image data to display the internal structure of the jaw bone, which allows the dentist to correlate the diagnostic spot on the cast model 40 to the anatomical imaging information under the stylus probe. In this embodiment, a tomographic image containing the anatomical image of the patient's mandible jaw bone (the dark area shown on the screen of the computer 10) of the spot of interest is shown in a real-time manner; thus, the user is able to plan the treatment and the following operation on the basis of the anatomical image of the patient shown on the computer 10 and the occlusal condition and aesthetic function provided by the cast model 40 at the same time.

Although the present invention has been explained in relation to its preferred embodiments, it is to be understood that many other possible modifications and variations can be made without departing from the spirit and scope of the invention as hereinafter claimed.

What is claimed is:

1. A system for facilitating surgical diagnosis and treatment planning by use of a cast model, said system comprising:
a computer for reading three-dimensional anatomical information comprising fiducial marker information and for rendering an anatomical image corresponding to the three-dimensional anatomical information;
a registration marker object comprising at least one fiducial marker whose position is consistent with the fiducial marker information; and
a localization means for probing a point on the cast model and transmitting corresponding spatial information thereof to the computer so as to specify the display of the anatomical image.

2. The system as claimed in claim 1, wherein the three-dimensional anatomical information is X-ray radiographic data.

3. The system as claimed in claim 2, wherein the three-dimensional anatomical information is selected from at least one member of the group consisting of intral-oral radiographic data, panoramic radiographic data, tomographic radiographic data, and computed tomographic radiographic data.

4. The system as claimed in claim 3, wherein the three-dimensional anatomical information is computed tomographic radiographic data.

5. The system as claimed in claim 1, wherein the anatomical image is a tomographic image.

6. The system as claimed in claim 1, wherein the registration marker object further comprises a main part on which the fiducial marker is disposed.

7. The system as claimed in claim 6, wherein the main part is a casting with a negative impression of teeth taken from the cast model.

8. The system as claimed in claim 1, wherein the registration marker object comprises three fiducial markers.

9. The system as claimed in claim 1, wherein the localization means is an articulated arm.

10. The system as claimed in claim 1, wherein the spatial information is transmitted by wireless means.

11. The system as claimed in claim 1, wherein the spatial information comprises a position and orientation of the point on the cast model.

12. A method for performing surgical diagnosis and treatment planning, comprising:
mounting a registration marker object comprising at least one fiducial marker onto a cast model secured at a predetermined place;
transmitting position information corresponding to the fiducial marker to a computer, wherein the computer is loaded with three-dimensional anatomical information comprising fiducial marker information;
aligning the three-dimensional anatomical information and the position information; and
receiving spatial information of a point on the cast model and displaying an anatomical image corresponding to the spatial information.

13. The method as claimed in claim 12, wherein the registration marker object further comprises a main part on which the fiducial marker is disposed.

14. The method of claim 13, wherein the main part is a casting with a negative impression of teeth taken from the cast model.

15. The method of claim 12, wherein the registration marker object comprises three fiducial markers.

16. The method of claim 12, wherein the three-dimensional anatomical information is X-ray radiographic data.

17. The method of claim 12, wherein the three-dimensional anatomical information is selected from at least one member of the group consisting of intral-oral radiographic data, panoramic radiographic data, tomographic radiographic data, and computed tomographic radiographic data.

18. The method of claim 17, wherein the three-dimensional anatomical information is computed tomographic radiographic data.

19. The method of claim 12, wherein the spatial information comprises a position and orientation of the point on the cast model.

20. The method of claim 12, wherein the anatomical image is a tomographic image.
